(19) United States
(12) Patent Application Publication
(10) Pub. No.: US 2012/0008941 A1
(43) Pub. Date: Jan. 12, 2012

(54) OPTICAL CHANNEL MONITOR AND METHOD OF CALCULATING SIGNAL LIGHT LEVEL OF OPTICAL CHANNEL MONITOR

(76) Inventor: Takefumi Oguma, Tokyo (JP)

(21) Appl. No.: 13/138,681

(22) PCT Filed: Mar. 11, 2010
(86) PCT No.: PCT/JP2010/054085

§ 371 Date: Sep. 19, 2011

(30) Foreign Application Priority Data
Mar. 24, 2009 (JP) 2009-072437

(51) Int. Cl. H04B 10/08

(52) U.S. Cl. 398/34

(57) ABSTRACT

An optical channel monitor, includes: a wavelength demultiplexer that demultiplexes input signal light; photodetectors that are arranged on a demultiplexed side of the wavelength demultiplexer, and receive light in a wavelength band wider than a wavelength band of the signal light; and a calculator that calculates a light level of signal light of each wavelength by means of linear compensation on the basis of a received light level of light in the wavelength band of the signal light and a received light level of light of a wavelength outside the wavelength band of the signal light at the photodetectors.

### TECHNICAL FIELD

The present invention relates to an optical channel monitor and a method of calculating a signal light level of an optical channel monitor.

### BACKGROUND ART

In recent years, with the advancement of communication technology using an optical fiber, WDM (wavelength division multiplex) communication has been developed. This WDM communication requires an optical channel monitor (hereinafter, referred to as OCM).

Optical channel monitors are largely categorized into a monochromator system and a polychromator system.

The monochromator system wavelength-sweeps an internally included optical filter, receives an output from the filter by a photodetector and monitors light levels at respective wavelengths of the incident light.

The polychromator system arranges photodetectors on a demultiplexed side of a wavelength demultiplexer, such as a diffraction grating, and monitors light levels at respective wavelengths of incident light by sweeping the received light level of the photodetectors.

Examples of techniques related to optical channel monitors are described in Patent Literature 1 to 5.

A wavelength multiplexing optical amplifier described in Patent Literature 1 includes input light measurement means, gain equalization means having loss wavelength characteristics suppressing wavelength dependence of a gain of optical amplification means, and changing the loss wavelength characteristics, and gain equalization control means for controlling the loss wavelength characteristics of the gain equalization means.

The wavelength multiplexing optical amplifier described in Patent Literature 1 is capable of securely compensating gain wavelength characteristics of the optical amplification means that are changed in response to input light power. Accordingly, output light having flat wavelength characteristics can be acquired. This allows securing wavelength flatness of the gain over a wide range of levels of input light and acquiring noise characteristics with a small wavelength dependence, and enables the worst value of noise characteristics in a signal band to be improved.

A WDM signal monitor described in Patent Literature 2 includes a spectroscope, a response characteristics data storing section, and a calculator that calculates optical SNRs of respective channels from sampling data of spectra between peaks of channels on the basis of the spectra and response characteristics data of a response characteristics data storing section.

The WDM signal monitor described in Patent Literature 2 thus measures optical SNRs of respective channels on the basis of the spectra measured by the spectroscope and the response characteristics data. This allows accurately measuring of the optical SNR (signal to noise ratio) in a modulated WDM signal.

A WDM signal monitor described in Patent Literature 3 includes a spectroscope, a response characteristics data storing section, a correction data storing section, a calculator that acquires an optical noise level on the basis of spectra, response characteristics data and correction data, and an adjustment section that acquires an optical noise level and calculates and stores correction data.

According to the WDM signal monitor described in Patent Literature 3, in adjustment, the adjustment section calculates the correction data from an error between the optical noise level acquired on the basis of the spectra acquired by the spectroscope and the optical noise level acquired by the calculator, and stores the correction data in the correction data storing section. In measurement, the calculator acquires the optical noise level on the basis of the spectra measured by the spectroscope, the response characteristics data and the correction data. Accordingly, the calculator can correct an error between the shape of the response characteristics data and response spectra of the spectroscope in measurement. This allows highly accurately acquiring the optical noise level without being influenced by time-dependent change, usage environment, a system of modulating a WDM signal and the like. This in turn allows highly accurately acquiring the optical SNR.

A WDM signal monitor described in Patent Literature 4 includes spectroscopes that include: photodiodes arranged in a prescribed direction, wavelength-disperses signal light in the prescribed direction and receives each piece of signal light; and power calculation means for acquiring the total power of the signal light according to an outputs from the photodiodes of the spectroscope.

The WDM signal monitor described in Patent Literature 4 adjusts the spectroscope, and receives dispersed pieces of signal light on alternate elements of photodiodes. The monitor then acquires the total power of the signal light according to outputs from the photodiodes which receive the signal light on the alternate element basis. Accordingly, in contrast to related arts, there is no need to increase the number of elements of the photodiodes even in a case where the WDM signals are multiplexed in high density. This allows measurement of the signal light using a small number of photodiodes, suppresses time of sweeping the photodiodes and time of calculation, and allows high speed measurement. Further, in contrast to the related arts, there is no need to narrow the pitch or the widths of the photodiodes. Accordingly, manufacturing yield is increased, thereby allowing the cost to be suppressed.

An optical amplifier of Patent Literature 5 includes gain control means for controlling a drive current supplied to a first gain stage in dependence on an optical input signal to the first gain stage, output control means for controlling the drive current, and compensating means for applying a correction coefficient on the basis of an ASE (amplified spontaneous emission) and an output from the first gain stage.

The optical amplifier described in Patent Literature 5 is adapted to provide ASE compensation in the output power control mode in a multi-stage amplifier while maintaining a single ASE calibration process involving calibration only in the gain control mode. By taking account of the ASE of preceding stages in the final stage ASE compensation, this configuration allows output and gain alarm handling to operate directly from detected measurement values without lengthy logarithmic and exponential calculations. Thus good noise performance can be achieved over a wide range of input signals, and a single optical amplifier can be used in different control modes and applications without the need for additional calibration.

### CITATION LIST

### Patent Literature

Patent Literature 1: JP2000-252923A

Patent Literature 2: JP2003-179554A

Patent Literature 3: JP2003-218797A

Patent Literature 4: JP2007-139578A

Patent Literature 5: JP2008-502162A

### SUMMARY OF INVENTION

### Technical Problem

Incidentally, the aforementioned monochromator system, in terms of the structure, requires an external reference light source in order to correct the time-dependent change of the optical filter and secure accuracy of wavelengths, and further requires time for sweeping the wavelengths. Accordingly, there is a problem that time is required for collecting data.

On the other hand, since the polychromator system causes the photodetectors to simultaneously collect data, the system collects data at high speed. However, such a configuration discriminates ASE components and signal light components from each other. This requires improvement in resolution. With this improvement, the number of photodetectors is increased, which resultantly increases the cost of parts.

Patent Literature 1 discloses that the detectors for detecting ASE are arranged immediately outside of short and long wave ends of the signal band. However, Patent Literature 1 does not disclose that the ASE components of the respective wavelength channels are acquired by proportional calculation.

Further, Patent Literature 5 discloses that compensation is made for removing the ASE component due to the preceding stage optical amplifier. However, Patent Literature 5 does not disclose how to detect the ASE.

Any one of the other Patent Literature does not disclose that magnitudes of the ASE components of the respective wavelength channels are acquired by proportional calculation from magnitudes of ASE at both ends of the wavelength multiplexing band.

It is an object of the present invention to provide an optical channel monitor capable of highly accurate OCM (optical channel monitor) at high speed and low cost, and a method of calculating the signal light level of an optical channel monitor.

### Solution to Problem

In order to attain the above object, a device of the present invention includes:
a wavelength demultiplexer that demultiplexes input signal light;
photodetectors that are arranged on a demultiplexed side of the wavelength demultiplexer, and receive light in a wavelength band wider than a wavelength band of the signal light; and
a calculator that calculates the light level of signal light of each wavelength by means of linear complements on the basis of the received light level of light in the wavelength band of the signal light and the received light level of light of a wavelength outside the wavelength band of the signal light at the photodetectors.

A method of the present invention calculates the light level of signal light of each wavelength by means of linear compensation on the basis of the received light level of light in a wavelength band of the signal light and the received light level of light of a wavelength outside the wavelength band of the signal light at photodetectors that are arranged on a demultiplexed side of a wavelength demultiplexer, and that receive light in a wavelength band wider than a wavelength band of the signal light input to the wavelength demultiplexer.

### Advantageous Effects of Invention

The present invention provides an optical channel monitor capable of highly accurate OCM (optical channel monitor) at high speed and low cost, and a method of calculating the signal light level of an optical channel monitor.

### BRIEF DESCRIPTION OF DRAWINGS

FIG. 1 is a block diagram showing an exemplary embodiment of an optical channel monitor.

FIG. 2 is a diagram showing a light receiving range on a wavelength axis detected by a monitor group shown in FIG. 1.

FIG. 3 is a diagram for illustrating an ASE component at the optical channel monitor shown in FIG. 1.

FIG. 4 is a flowchart for illustrating an operation of the optical channel monitor shown in FIG. 1.

### DESCRIPTION OF EMBODIMENT

<Characteristics>

According to an optical channel monitor and a method of calculating according to the present invention, a signal light level of an optical channel monitor, in OCM of a polychromator system, detectors for detecting ASE are arranged immediately outside of short and long wave ends of the signal band, and ASE components are detected and reflected in detection values of detectors for detecting signals. This allows highly accurate detection of the optical power of a signal light component at high speed with a small number of detectors (A calculation process by a calculator allows the number of detectors to be suppressed to the minimum). Note that “reflected in detection values” means calculation of equations (1) and (2) by the calculator.

<Configuration>

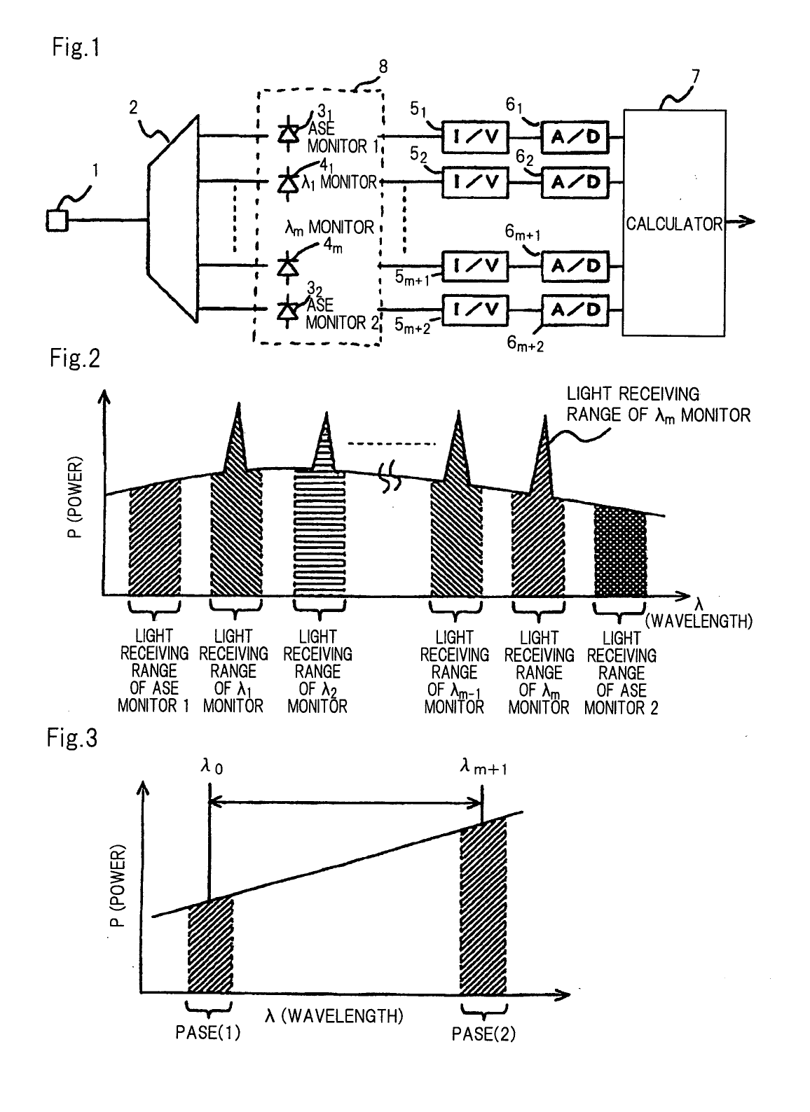

FIG. 1 is a block diagram showing an exemplary embodiment of an optical channel monitor.

As shown in FIG. 1, optical channel monitor 10 according to this exemplary embodiment includes demultiplexer 2, monitor group 8 (ASE monitors 3₁ and 3₂ and λ₁ monitor 4₁, λ₂ monitor and 4₂, . . . , monitor 4ₘ) as photodetectors, I/V converters 5₁, 5₂, . . . , 5ₘ₊₁ and 5ₘ₊₂, A/D converters 6₁, 6₂, . . . , 6ₘ₊₁ and 6ₘ₊₂ and calculator 7.

Demultiplexer 2 is an element that demultiplexes light including a WDM signal, which is signal light input in input terminal 1, and may be, for instance, any one of a diffraction grating type, a dielectric multilayer film type and a distributed coupling type. Demultiplexer 2 may include a pair of slab waveguides and array of waveguides that have different lengths and that are connected between the opposite slab waveguides.

In monitor group 8, λ₁ monitor 4₁, λ₂ monitor 4₂, . . . , and λₘ monitor 4ₘ are elements that receive respective WDM signals of wavelengths λ₁ to λₘ in light demultiplexed by demultiplexer 2 and convert the received signals into electric signals.

On the other hand, ASE monitor 1 (3₁) and ASE monitor 2 (3₂) detect a spontaneous emission light level, and at least receive light of wavelengths other than wavelengths λ₁ to λₘ, that is, light of wavelengths other than the wavelength band of the signal light input into input terminal 1, and convert the received light into electric signals.

For instance, typical infrared PIN-PDs (photo diodes) are applicable to monitor group 8.

I/V converters 5₁, 5₂, . . . , 5ₘ₊₁ and 5ₘ₊₂ are circuits that convert an electric current into a voltage; for instance, a transimpedance amplifier, log amplifier and CCD (charge coupled device) are applicable thereto.

The transimpedance amplifier may be, for instance, a circuit in which a resistor and a capacitor are connected between an inverted input terminal and an output terminal. This transimpedance amplifier efficiently generates a photocurrent, which flows through a feedback resistor generating a voltage V=iR at the output of the amplifier.

The log amplifier is a type of amplifier and is a circuit with which an output voltage becomes a logarithmic function (log) with respect to an input voltage.

A/D converters 6₁, 6₂, . . . , 6ₘ₊₁ and 6ₘ₊₂ are circuits that convert an analog signal into a digital signal.

Calculator 7 is a circuit having a function of calculating light levels of signal light having respective wavelengths on the basis of received light levels in the wavelength band of the signal light and received light levels of wavelengths outside the wavelength band of the signal light. Calculator 7 executes various operations, such as four basic operations and logical operations, and includes for instance a multiplier and an adder. Calculator 7 may be, for instance, a digital processor, such as a DSP (digital signal processor) and a CPU (central processing unit).

<Operation>

Starting from the left in FIG. 1, wavelength multiplexed transmission light (WDM light) from a transmission line (not shown) is incident on input terminal 1.

The incident WDM light is incident on demultiplexer 2. Demultiplexer 2 has WDM signal channels (channels λ₁ to λₘ in the diagram) and additionally has two channels adjacent to the short and long wave ends of the signal band.

Each channel adheres to signal light wavelengths specified by ITU-T (International Telecommunication Union-Telecommunication (ITU) Standardization Sector Recommendation). For instance, in the L-band, λ1=191.9 THz, λ41=196.9 THz (wavelength interval 100 GHz) and the like are used.

The signal light of each channel demultiplexed by demultiplexer 2 and the ASE component, which is spontaneous emission light, are incident on ASE monitors 3₁ and 3₂ and λ₁ monitor 4₁, λ₂ monitor 4₂, . . . , and λₘ monitor 4ₘ arranged at the output in monitor group 8, photoelectric-converted, I/V-converted and A/D-converted and then input into calculator 7.

Next, variables and assumptions used in operations of calculator 7 employed in the optical channel monitor according to the present invention will be listed.

FIG. 2 is a diagram showing a light receiving range on a wavelength axis detected by monitor group 8 shown in FIG. 1. In FIG. 2, the abscissa indicates the wavelength and the ordinate indicates the power of the signal light.

The range (bandwidth) of the optical channel monitor is dependent on the performance of demultiplexer 2. However, it is specified that the bandwidth is narrower than the difference between adjacent signal light wavelengths and wider than the sum of accuracy of the oscillation wavelength of the signal light and the modulation bit rate. It is further specified that design values within detection wavelength ranges of all the channels are equal to each other.

In FIG. 2, upper pulses have a certain height. However, the pulses are not limited thereto. The characteristic curve of the signal light power is upwardly curved; the curve is complemented in a region where the curve can be regarded as linear.

Optical powers detected by ASE monitors 1 (3₁) and 2 (3₂) shown in FIGS. 1 and 2 are represented by P_{ASE}(1) and P_{ASE}(2). The optical power in a channel number n detected by each λ(CH) monitor is represented by Pλ(n), in which a power due to the ASE component is represented by Pλ_{ASE}(n) and a power due to the signal light is Pλ_{SIG}(n). In this case, Pλ(n) is represented by equation (1).

Pλ(n)=Pλ_{ASE}(n)+Pλ_{SIG}(n) (1)

On the other hand, channel assignment (passing center wavelengths of respective ports of the demultiplexer) is that λ₁: the shortest ITU-T grid wavelength of the signal light wavelengths, λₘ: the longest grid wavelength, ASE monitor 1 is shorter than λ₁ by one grid (channel interval of demultiplexer) (represented as λ₀), and ASE monitor 2 is longer than λₘ by one grid (represented as λₘ₊₁).

FIG. 3 is a diagram for illustrating an ASE component at optical channel monitor 10 shown in FIG. 1. In FIG. 3, the abscissa indicates the wavelength and the ordinate indicates the power.

As shown in FIG. 3, experientially, the ASE is linear with respect to the wavelength, and Pλ_{ASE}(n) is represented by equation (2).

Pλ_{ASE}(n)=[P_{ASE}(2)−P_{ASE}(1)]×(λₙ−λ₀)/([λₘ₊₁]−λ₀)+P_{ASE}(1) (2)

Next, an operation (operation flow) of optical channel monitor 10 shown in FIG. 1 will be described.

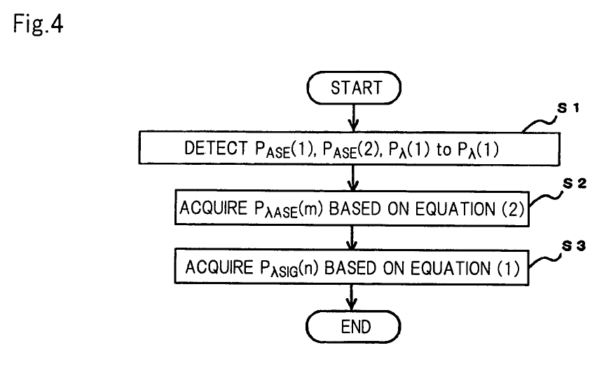

FIG. 4 is a flowchart for illustrating an operation of the optical channel monitor shown in FIG. 1.

In a first step (step S1), detected values of P_{ASE}(1), P_{ASE}(2) and Pλ(1) to Pλ(m) are captured into calculator 7 via I/V converters 5₁ to 5ₘ₊₂ and A/D converters 6₁ to 6ₘ₊₂.

In a second step (step S2), the operation of equation (2), which is a linear complement, is executed in calculator 7 and Pλ_{ASE}(n) is calculated.

In a third step (step S3), the operation of equation (1) is executed, Pλ_{SIG}(n) is calculated and the operated result is output.

That is, calculator 7 calculates light levels of signal light of the respective wavelengths, using interpolation, by subtracting the spontaneous emission light level from light levels received by λ₁ monitor 4₁, λ₂ monitor 4₂, . . . , λₘ monitor 4ₘ and ASE monitor 1 (3₁) and ASE monitor 2 (3₂).

Here, the optical powers denoted by reference signs P are acquired under the assumption of employing linear amplifiers as I/V converters 5₁ to 5ₘ₊₂ and the assumption that the input optical power (unit: mW) into each photodetector and the A/D-converted value are calibrated against each other. In calculator 7, the operation is executed using the A/D-converted value and subsequently the operated result is converted into the optical power on the basis of a calibration table. If required, a logarithm of the operated optical power is calculated, and the power is thus converted into units of dBm, which are typical units of light intensity, and Pλ_{SIG}(n) operation result of each channel is output.

That is, in the present invention, Pλ_{ASE}(n) is not actually measured as with the polychromator system but is acquired by estimation by means of linear compensation according to equation (2).

<Description of Advantageous Effect>

An advantageous effect of the optical channel monitor according to the present invention is as follows.

A highly accurate and high speed OCM can be realized at low cost.

This is because, although the polychromator system is adopted, the ASE component can be detected and separated with a small number of detectors.

The above exemplary embodiment is an example of exemplary embodiments. The present invention is not limited thereto. Various modifications can be made within a scope not deviating from the gist.

For instance, in the above exemplary embodiment, description has been made using the case where the light levels of signal light of the respective wavelengths use interpolation. The present invention is not limited thereto. That is, photodetectors for spontaneous emission light may be arranged at two middle points in the wavelength channel, or a photodetector for spontaneous emission light may be arranged in an unassigned wavelength channel. The light levels of signal light of the respective wavelengths may be calculated using extrapolation.

A typical polychromator system is different from that of the invention of this application in that the system measures the levels of prescribed wavelengths by actual sampling using PDs and the like instead of “complement” used in the invention of this application. For instance, as shown in FIG. 10 in Patent Literature 2, PDs are arranged in parallel; the center of measured light is regarded as a signal light level, and an area between circles is regarded as Pλ_{ASE}(n). Thus, a typical polychnimator system actually measures ASE.

The present invention has been described above with reference to the exemplary embodiment. However, the invention of this application is not limited to the above embodiment. Various modifications that those skilled in the art can understand may be made to the configuration and details of the invention of this application within the scope of the invention of this application.

This application claims the priority of Japanese Patent Application No. 2009-72437, filed Mar. 24, 2009, the disclosure of which is incorporated herein by reference in its entirety.

1. An optical channel monitor, comprising:
a wavelength demultiplexer that demultiplexes input signal light;
photodetectors that are arranged on a demultiplexed side of the wavelength demultiplexer, and receive light in a wavelength band wider than a wavelength band of the signal light; and
a calculator that calculates a light level of signal light of each wavelength by means of linear compensation on the basis of a received light level of light in the wavelength band of the signal light and a received light level of light of a wavelength outside the wavelength band of the signal light at the photodetectors.

2. The optical channel monitor according to claim 1,
wherein the calculator calculates the light level of the signal light of each wavelength by subtracting the light level of the light of the wavelength outside the wavelength band of the signal light from the light level of the light received by the photodetector, using interpolation.

3. The optical channel monitor according to claim 2,
wherein the photodetectors include
photodetectors for light of wavelengths outside the wavelength band of the signal light, and
photodetectors for light of wavelengths in the wavelength band of the signal light, and
the calculator, provided that optical powers detected by the photodetectors for the light of the wavelengths outside the wavelength band of the signal light are represented by P_{ASE}(1) and P_{ASE}(2), an optical power detected by the photodetectors for the light of the wavelengths in the wavelength band of the signal light is represented by Pλ(n), among which a power due to spontaneous emission light is represented by Pλ_{ASE}(n) and a power due to the signal light is represented by Pλ_{SIG}(n), a shortest ITU-T grid wavelength among the signal light wavelengths is represented by λ₁, and a longest grid wavelength thereamong is represented by λₘ, calculates the light levels of the signal light of the respective wavelengths on the basis of:
Pλ(n)=Pλ_{ASE}(n)+Pλ_{SIG}(n); and
Pλ_{ASE}(n)=[P_{ASE}(2)−P_{ASE}(1)]×(λₙ−λ₀)/([λₘ₊₁]−λ₀)+P_{ASE}(1).

4. The optical channel monitor according to claim 3,
wherein the photodetectors for the light of the wavelengths in the wavelength band of the signal light are arranged at two middle points in a wavelength channel.

5. The optical channel monitor according to claim 3,
wherein the photodetectors for the light of the wavelengths in the wavelength band of the signal light are arranged in an unassigned channel in wavelength channels.

6. A method of calculating a signal light level of an optical channel monitor, the method calculating a light level of signal light of each wavelength by means of linear compensation on the basis of a received light level of light in a wavelength band of the signal light and a received light level of light of a wavelength outside the wavelength band of the signal light at photodetectors that are arranged on a demultiplexed side of a wavelength demultiplexer, and that receive light in a wavelength band wider than a wavelength band of the signal light input to the wavelength demultiplexer.

7. The method of calculating a signal light level of an optical channel monitor according to claim 6,
wherein the method calculates the light level of the signal light of each wavelength by subtracting the light level of the light of the wavelength outside the wavelength band of the signal light from the light level of the light received by the photodetector, using interpolation.

8. The method of calculating a signal light level of an optical channel monitor according to claim 7,
the method, provided in which optical powers detected by the photodetectors for the light of the wavelengths outside the wavelength band of the signal light are represented by P_{ASE}(1) and P_{ASE}(2), an optical power detected by the photodetectors for the light of the wavelengths in the wavelength band of the signal light is represented by Pλ(n), among which a power due to spontaneous emission light is represented by Pλ_{ASE}(n) and a power due to the signal light is represented by Pλ_{SIG}(n), a shortest ITU-T grid wavelength among the signal light wavelengths is represented by λ₁, and a longest grid wavelength thereamong is represented by λₘ, calculates the light levels of the signal light of the respective wavelengths on the basis of:
Pλ(n)=Pλ_{ASE}(n)+Pλ_{SIG}(n); and
Pλ_{ASE}(n)=[P_{ASE}(2)−P_{ASE}(1)]×(λₙ−λ₀)/([λₘ₊₁]−λ₀)+P_{ASE(}1).
